(19) United States
(12) Patent Application Publication
(10) Pub. No.: US 2011/0175940 A1
(43) Pub. Date: Jul. 21, 2011

(54) PROJECTION DISPLAY APPARATUS AND IMAGE ADJUSTMENT METHOD

(75) Inventors: Tomoya Terauchi, Daito-City (JP); Yoshinao Hiranuma, Hirakata-City (JP); Susumu Tanase, Kadoma-city (JP); Takaaki Abe, Osaka-city (JP); Masahiro Haraguchi, Daito-city (JP); Noboru Yoshinobe, Hirakata-city (JP); Masutaka Inoue, Hirakata-city (JP)

(73) Assignee: SANYO ELECTRIC CO., LTD., Osaka (JP)

(21) Appl. No.: 12/979,879

(22) Filed: Dec. 28, 2010

(30) Foreign Application Priority Data
Dec. 28, 2009 (JP) 2009-298973
Oct. 27, 2010 (JP) 2010-241127

(51) Int. Cl. G09G 5/10

(52) U.S. Cl. 345/690

(57) ABSTRACT

A projection display apparatus includes: an imager configured to modulate light emitted from a light source; a projection unit configured to project light coming from the imager on a projection plane; a detection unit configured to detect a projection frame provided on the projection plane; and an imager controller configured to control the imager so that a position of an image projected on the projection plane is moved in a projectable range within which the projection unit is able to project an image. The imager controller controls the imager so that the image projected on the projection plane fits within the projection frame.

### CROSS REFERENCE TO RELATED APPLICATIONS

This application is based upon and claims the benefit of priority from prior Japanese Patent Application No. 2009-298973, filed on Dec. 28, 2009; and prior Japanese Patent Application No. 2010-241127, filed on Oct. 27, 2010, the entire contents of which are incorporated herein by reference.

### BACKGROUND OF THE INVENTION

1. Field of the Invention

The present invention relates to a projection display apparatus including: an imager configured to modulate light emitted from a light source; and a projection unit configured to project light coming from the imager on a projection plane, and to an image adjustment method.

2. Description of the Related Art

A projection display apparatus has heretofore been known which includes: an imager configured to modulate light emitted from a light source; and a projection unit configured to project light coming from the imager on a projection plane.

It is conceivable that a range within which the projection display apparatus (projection unit) can project an image (hereinafter called a projectable range) may not match a projection frame provided on a projection plane.

To cope with this, there is disclosed a method of fitting an image, which is included in a projectable range, within a projection frame with the following procedure (Japanese Patent Application Publication No. 2008-251026, for example). Firstly, a projection display apparatus images a projection plane, and identifies coordinates of four corners of a projection frame (which is defined by a screen frame, for example) provided on the projection plane. Secondly, the projection display apparatus identifies coordinates of four corners of an image projected on the projection plane. Thirdly, the projection display apparatus corrects an image signal so that the image may fit within the projection frame, on the basis of the coordinates of the four corners of the projection frame and the coordinates of the four corners of the image.

However, projectable range is fixed according to the above technique. Thus, even if a display position of the image on the projection plane needs to be changed, the display position of the image cannot be changed as desired due to the constraints of the projectable range.

### SUMMARY OF THE INVENTION

A projection display apparatus of a first aspect includes: an imager (liquid crystal panel 50) configured to modulate light emitted from a light source (light source 10); a projection unit (projection unit 110) configured to project light coming from the imager on a projection plane; a detection unit (detection unit 240) configured to detect a projection frame provided on the projection plane; and an imager controller (imager controller 270) configured to control the imager so that a position of an image projected on the projection plane is moved in a projectable range within which the projection unit is able to project an image. The imager controller controls the imager so that the image projected on the projection plane fits within the projection frame.

In the first aspect, the imager controller controls the imager so that the imager displays any one of an indicator indicating a direction in which the image projected on the projection plane is movable in the projection frame and an indicator indicating a direction in which the image projected on the projection plane is expandable or shrinkable in the projection frame.

In the first aspect, the projection display apparatus further includes a projection unit controller (projection unit controller 260) configured to control the projection unit so that the projection unit moves a position of the projectable range. The imager controller controls the imager so that the image projected on the projection plane fits within the projection frame in conjunction with the movement of the position of the projectable range.

In the first aspect, the imager controller controls the imager so that the position of the image projected on the projection plane is moved in the projectable range in conjunction with expansion or shrinkage of the projectable range, without changing a center position of the image projected on the projection plane.

In the first aspect, the imager controller controls the imager so that the imager displays a candidate position at which the image projected on the projection plane is displayable in the projection frame.

In the first aspect, the detection unit detects the projection frame by detecting a detection target provided on the projection plane.

In the first aspect, the imager controller includes a first operation mode and a second operation mode to control the imager. The image projected on the projection plane is moved in certain moving steps in the first operation mode. The image projected on the projection plane is moved to reach an edge of a movable range of the image in the second operation mode.

In the first aspect, the projection display apparatus further includes a calculation unit (calculation unit 250) configured to figure out a range in which the projectable range and the projection frame overlap with each other. The imager controller controls the imager so that the imager displays the overlap range figured out.

In the first aspect, when the image projected on the projection plane is forced to move beyond a movable range of the image, the imager controller controls the imager so that a region where no image is projected is expanded in the projection frame.

In the first aspect, when the image projected on the projection plane is forced to move beyond a movable range of the image, the imager controller controls the imager so that the image projected on the projection plane is made translucent.

In the first aspect, the projection display apparatus further includes: a remote controller (remote controller 500) configured to transmit an instruction issued to the imager controller to move the position of the image projected on the projection plane; and first and second reception units (front reception unit 130, a rear reception unit 140) each configured to receive a signal transmitted from the remote controller. The imager controller controls the imager so that a direction in which the image projected on the projection plane is moved in response to the instruction received by the first reception unit from the remote controller is opposite to a direction in which the image projected on the projection plane is moved in response to the instruction received by the second reception unit from the remote controller.

### BRIEF DESCRIPTION OF THE DRAWINGS

FIG. 1 is a view showing an outline of a projection display apparatus 100 according to a first embodiment of the present invention.

FIG. 2 is a view showing a configuration of the projection display apparatus 100 according to the first embodiment.

FIG. 3 is a block diagram showing a control unit 200 according to the first embodiment.

FIG. 4 is a view showing an example of a stored test pattern image according to the first embodiment.

FIG. 5 is a view showing an example of the stored test pattern image according to the first embodiment.

FIG. 6 is a view showing an example of the stored test pattern image according to the first embodiment.

FIG. 7 is a view showing an example of the stored test pattern image according to the first embodiment.

FIG. 8 is a view showing an example of the stored test pattern image according to the first embodiment.

FIG. 9 is a view showing an example of the stored test pattern image according to the first embodiment.

FIG. 10 is a view illustrating a method of calculating an intersection point in a projected test pattern image according to the first embodiment.

FIG. 11 is a view showing a display example of an indicator according to the first embodiment.

FIG. 12 is a view showing a display example of the indicator according to the first embodiment.

FIG. 13 is a flowchart showing an operation of the projection display apparatus 100 according to the first embodiment.

FIG. 14 is a view showing an example of shrinking an image according to a first modification example of the first embodiment.

FIG. 15 is a view showing the example of shrinking the image according to the first modification example.

FIG. 16 is a view showing an example of expanding an image according to the first modification example.

FIG. 17 is a view showing the example of expanding the image according to the first modification example.

FIG. 18 is a view showing a display example of candidate positions according to a second modification example of the first embodiment.

FIG. 19 is a view showing a display example of candidate positions according to the second modification example.

FIG. 20 is a view showing an example of detecting a projection frame 420 according to a third modification example of the first embodiment.

FIG. 21 is a view showing an example of detecting the projection frame 420 according to the third modification example.

FIG. 22 is a view showing an example of detecting the projection frame 420 according to the third modification example.

FIG. 23 is a view showing an example of adjusting an aspect ratio according to a fourth modification example of the first embodiment.

FIG. 24 is a view showing an example of adjusting the aspect ratio according to the fourth modification example.

FIG. 25 is a view showing an example of a display for selection on whether the aspect ratio needs to be adjusted, according to a fifth modified example of the first embodiment.

FIG. 26 is a view showing an example of displaying multiple images 430 in parallel according to a sixth modified example of the first embodiment.

FIG. 27 is a view showing an example of displaying the multiple images 430 in parallel according to the sixth modified example.

FIG. 28 is a view showing an example where an imager controller 270 readjusts the size of the image 430 in response to change of the aspect ratio of the image 430 during projection, according to a seventh modified example of the first embodiment.

FIG. 29 is a view showing the example where the imager controller 270 readjusts the size of the image 430 in response to change of the aspect ratio of the image 430 during projection, according to the seventh modified example.

FIG. 30 is a view showing an example of operation modes different in the amount of movement according to an eighth modified example of the first embodiment.

FIG. 31 is a view showing the example of the operation modes different in the amount of movement according to the eighth modified example.

FIG. 32 is a view showing an example of displaying a movable range 450 of the image 430 according to a ninth modified example of the first embodiment.

FIG. 33 is a view showing a case where the user moves the image 430 beyond a movable limit of the image, according to a tenth modified example of the first embodiment.

FIG. 34 is a view showing the case where the user moves the image 430 beyond the movable limit, according to the tenth modified example.

FIG. 35 is a view showing another way of handling according to the tenth modified example.

FIG. 36 is a view showing directions in which the image 430 is moved by an operation of direction keys of a remote controller 500 from positions anterior to and posterior to the projection display apparatus 100, according to an eleventh modified example of the first embodiment.

FIG. 37 is a view showing another way of handling according to the eleventh modified example.

FIG. 38 is a view showing an interactive pen 600 functions as a remote controller for moving the image 430, according to a twelfth modified example of the first embodiment.

FIG. 39 is a view showing another way of handling according to the twelfth modified example.

### DETAILED DESCRIPTION OF THE EMBODIMENTS

Hereinbelow, a projection display apparatus according to embodiments of the present invention will be described with reference to the drawings. Note that, in the following description of the drawings, same or similar reference numerals denote same or similar elements and portions.

It should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### Summary of Embodiments

The projection display apparatus according to the embodiments includes: an imager configured to modulate light emitted from a light source; and a projection unit configured to project light coming from the imager on a projection plane. The projection display apparatus includes: a detection unit configured to detect a projection frame provided on the projection plane; a projection unit controller configured to control the projection unit so that the projection unit may move a position of a projectable range within which the projection unit can project an image; and an imager controller configured to control the imager so that an image projected on the projection plane can be moved in the projectable range. The imager controller controls the imager so that the image projected on the projection plane may fit within the projection frame.

In this way, according to the embodiments, an image projected on the projection plane is controlled to fit within the projection plane. Accordingly, a display position of an image projected on the projection plane can be changed flexibly.

### First Embodiment

### Outline of Projection Display Apparatus

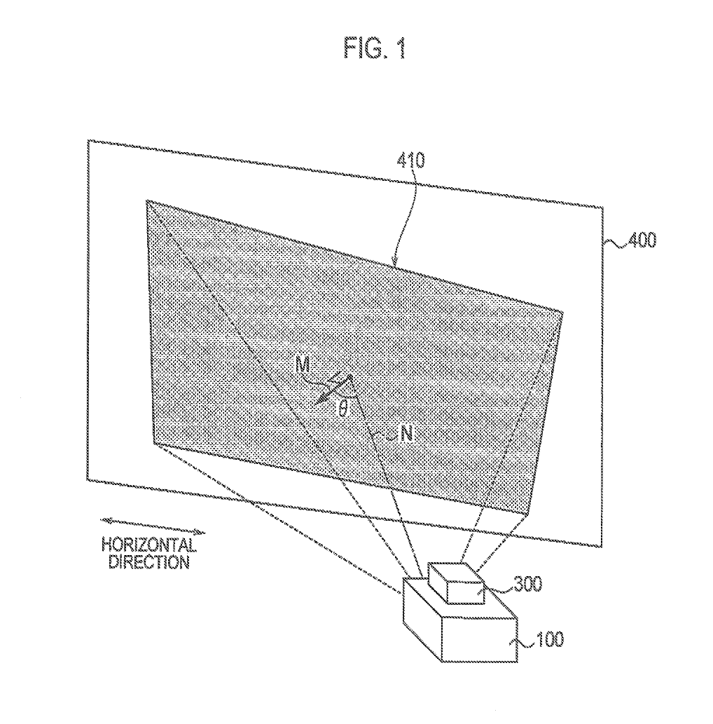

A projection display apparatus according to a first embodiment of the present invention will be described below with reference to the drawing. FIG. 1 is a view showing an outline of a projection display apparatus 100 according to the first embodiment.

As shown in FIG. 1, the projection display apparatus 100 is provided with an imaging device 300. The projection display apparatus 100 projects image light on a projection plane 400.

The imaging device 300 is configured to image the projection plane 400. In other words, the imaging device 300 is configured to detect reflected light of the image light projected on the projection plane 400 by the projection display apparatus 100. The imaging device may be embedded in the projection display apparatus 100, or may be installed in combination with the projection display apparatus 100.

The projection plane 400 is formed of a screen or the like. A range within which the projection display apparatus 100 can project image light (projectable range 410) is formed on the projection plane 400. The projection plane 400 includes a display area defined by the outer frame of the screen or the like.

In the first embodiment, description is given of a case where an optical axis N of the projection display apparatus 100 does not coincide with a normal M of the projection plane 400. For example, description is given of a case where the optical axis N and the normal M form an angle θ.

Specifically, in the first embodiment, since the optical axis N and the normal M do not coincide with each other, the projectable range 410 (image displayed on the projection plane 400) is distorted. In the first embodiment, description is mainly given of a method of correcting such distortion of the projectable range 410.

(Configuration of Projection Display Apparatus)

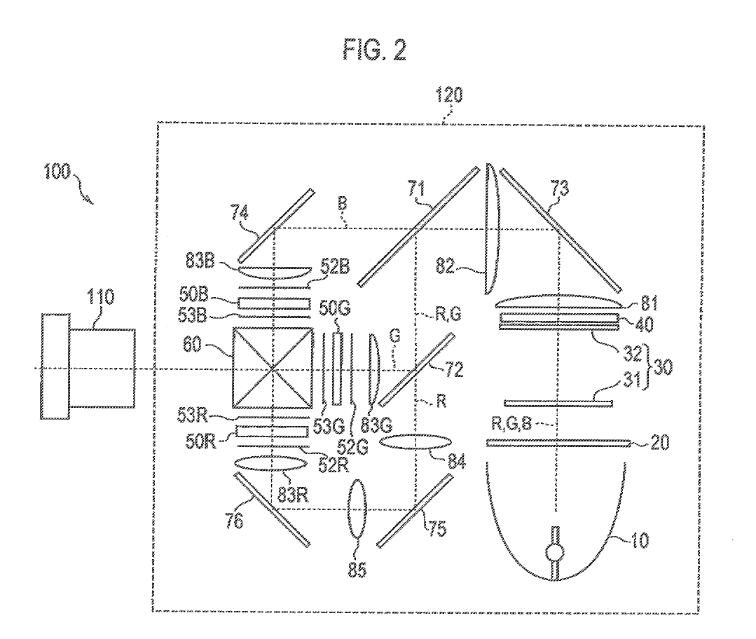

The projection display apparatus according to the first embodiment will be described below with reference to the drawing. FIG. 2 is a view showing a configuration of the projection display apparatus 100 according to the first embodiment.

As shown in FIG. 2, the projection display apparatus 100 includes a projection unit 110 and an illumination device 120.

The projection unit 110 projects image light coming from the illumination device 120, on a projection plane (not shown) or the like.

Firstly, the illumination device 120 includes a light source 10, a UV/IR cut filter 20, a fly-eye lens unit 30, a PBS array 40, multiple liquid crystal panels 50 (a liquid crystal panel 50R, a liquid crystal panel 50G, and a liquid crystal panel 50B), and a cross dichroic prism 60.

Examples of the light source 10 include a UHP lamp and a xenon lamp configured to emit white light. Specifically, light emitted by the light source 10 includes red component light R, green component light G, and blue component light B.

The UV/IR cut filter 20 transmits visible light components (red component light R, green component light G, and blue component light B). On the other hand, the UV/IR cut filter 20 shields an infrared light component and an ultraviolet light component.

The fly-eye lens unit 30 equalizes the light emitted from the light source 10. Specifically, the fly-eye lens unit 30 includes a fly-eye lens 31 and a fly-eye lens 32. The fly-eye lens 31 and the fly-eye lens 32 are each formed of multiple microlenses. Each of the microlenses condenses the light emitted from the light source 10 so that the entire surface of each liquid Crystal panel 50 may be irradiated with the light emitted from the light source 10.

The PBS array 40 aligns the polarization state of the light coming from the fly-eye lens unit 30. For example, the PBS array 40 aligns the light coming from the fly-eye lens unit 30 to S-polarization (or P-polarization).

The liquid crystal panel 50R modulates the red component light R on the basis of a red output signal Rₒᵤₜ. An incident-side polarizing plate 52R is provided at the side of the liquid crystal panel 50R on which light is incident. The incident-side polarizing plate 52R transmits light having one polarization direction (for example, S-polarization), and shields light having any other polarization direction (for example, P-polarization). Meanwhile, an output-side polarizing plate 53R is provided at the side of the liquid crystal panel 50R through which the light is outputted. The output-side polarizing plate 53R shields light having one polarization direction (for example, S-polarization), and transmits light having any other polarization direction (for example, P-polarization).

The liquid crystal panel 50G modulates the green component light G on the basis of a green output signal Gₒᵤₜ. An incident-side polarizing plate 52G is provided at the side of the liquid crystal panel 50G on which light is incident. The incident-side polarizing plate 52G transmits light having one polarization direction (for example, S-polarization), and shields light having any other polarization direction (for example, P-polarization). Meanwhile, an output-side polarizing plate 53G is provided at the side of the liquid crystal panel 50R through which the light is outputted. The output-side polarizing plate 53G shields light having one polarization direction (for example, S-polarization), and transmits light having any other polarization direction (for example, P-polarization).

The liquid crystal panel 50B modulates the blue component light B on the basis of a blue output signal Bₒᵤₜ. An incident-side polarizing plate 52B is provided at the side of the liquid crystal panel 50B on which light is incident. The incident-side polarizing plate 52B transmits light having one polarization direction (for example, S-polarization), and shields light having any other polarization direction (for example, P-polarization). Meanwhile, an output-side polarizing plate 53B is provided at the side of the liquid crystal panel 50B through which the light is outputted. The output-side polarizing plate 53B shields light having one polarization direction (for example, S-polarization), and transmits light having any other polarization direction (for example, P-polarization).

Note that, the red output signal Rₒᵤₜ, the green output signal Gₒᵤₜ, and the blue output signal Bₒᵤₜ constitute an image output signal. The image output signal is produced for each of multiple pixels constituting one frame.

Each of the liquid crystal panels 50 may be provided with a compensation plate (not shown) which improves a contrast ratio and transmittance. Moreover, each of the polarizing plates may be provided with a pre-polarizing plate which reduces the amount of light to be incident on the polarizing plate and the thermal load on the polarizing plate.

The cross dichroic prism 60 constitutes a color combination unit which combines the light beams coming from the liquid crystal panels 50R, 50G, and 50B. The combined light coming from the cross dichroic prism 60 is guided to the projection unit 110.

Secondly, the illumination device 120 includes a mirror group (mirrors 71 to 76) and a lens group (lenses 81 to 85).

The mirror 71 is a dichroic mirror which transmits the blue component light B and reflects the red component light R and the green component light G. The mirror 72 is a dichroic mirror which transmits the red component light R and reflects the green component light G. The mirrors 71 and 72 constitute a color separation unit which separates the red component light R, the green component light G, and the blue component light B from one another.

The mirror 73 reflects the red component light R, the green component light G, and the blue component light B to guide them toward the mirror 71. The mirror 74 reflects the blue component light B to guide it toward the liquid crystal panel 50B. The mirrors 75 and 76 reflect the red component light R to guide it toward the liquid crystal panel 50R.

The lens 81 is a condenser lens which condenses light outputted from the PBS array 40. The lens 82 is a condenser lens which condenses light reflected by the mirror 73.

The lens 83R forms the red component light R into substantially collimated light so that the liquid crystal panel 50R can be irradiated with the red component light R. The lens 83G forms the green component light G into substantially collimated light so that the liquid crystal panel 50G can be irradiated with the green component light G. The lens 83B forms the blue component light B into substantially collimated light so that the liquid crystal panel 50B can be irradiated with the blue component light B.

The lenses 84 and 85 are relay lenses which form an approximate image of the red component light R on the liquid crystal panel 50R while suppressing expansion of the red component light R.

(Configuration of Control Unit)

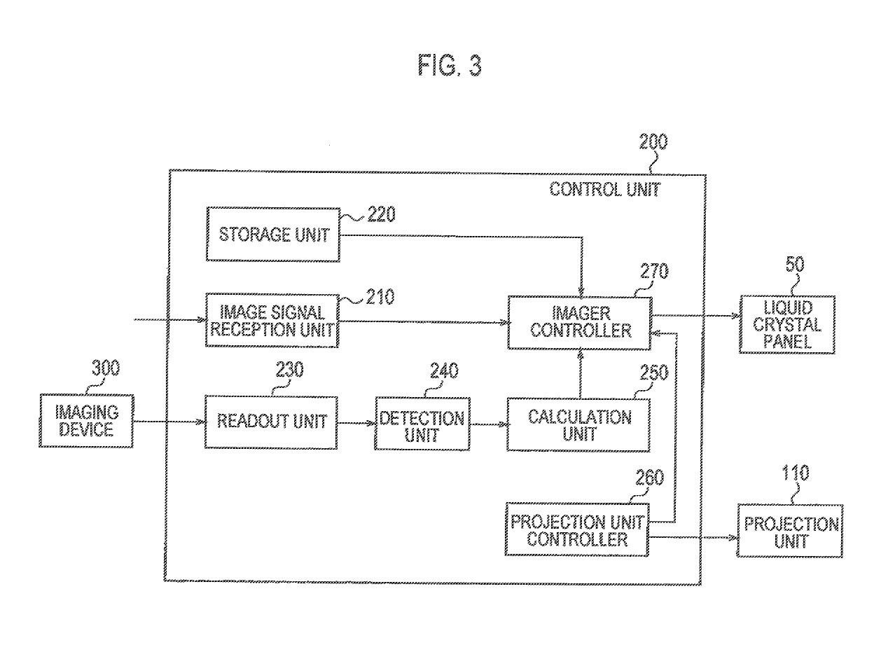

A control unit according to the first embodiment will be described below with reference to the drawing. FIG. 3 is a block diagram showing a control unit 200 according to the first embodiment. The control unit 200 is installed in and controls the projection display apparatus 100.

The control unit 200 converts an image input signal into an image output signal. The image input signal is formed of a red input signal Rᵢₙ, a green input signal Gᵢₙ, and a blue input signal Bᵢₙ. The image output signal is formed of a red output signal Rₒᵤₜ, a green output signal Gₒᵤₜ, and a blue output signal Bₒᵤₜ. A set of the image input signal and the image output signal is produced for each of multiple pixels constituting one frame.

As shown in FIG. 3, the control unit 200 includes an image signal reception unit 210, a storage unit 220, a readout unit 230, a detection unit 240, a calculation unit 250, a projection unit controller 260, and an imager controller 270.

The image signal reception unit 210 receives an image input signal from an external device such as a DVD or a TV tuner (not shown).

The storage unit 220 stores therein various types of information. To be more specific, the storage unit 220 stores a test pattern image which is formed of at least parts of three or more line segments defining three or more intersection points. Each of the three or more line segments is inclined relative to a given readout direction.

Here, the given readout direction is a direction of a given line forming the test pattern image. It should be noted that, as will be described later, for each given line forming the test pattern image, the readout unit 230 reads data of a shot image corresponding to the given line into a line buffer, the shot image being imaged by the imaging device 300.

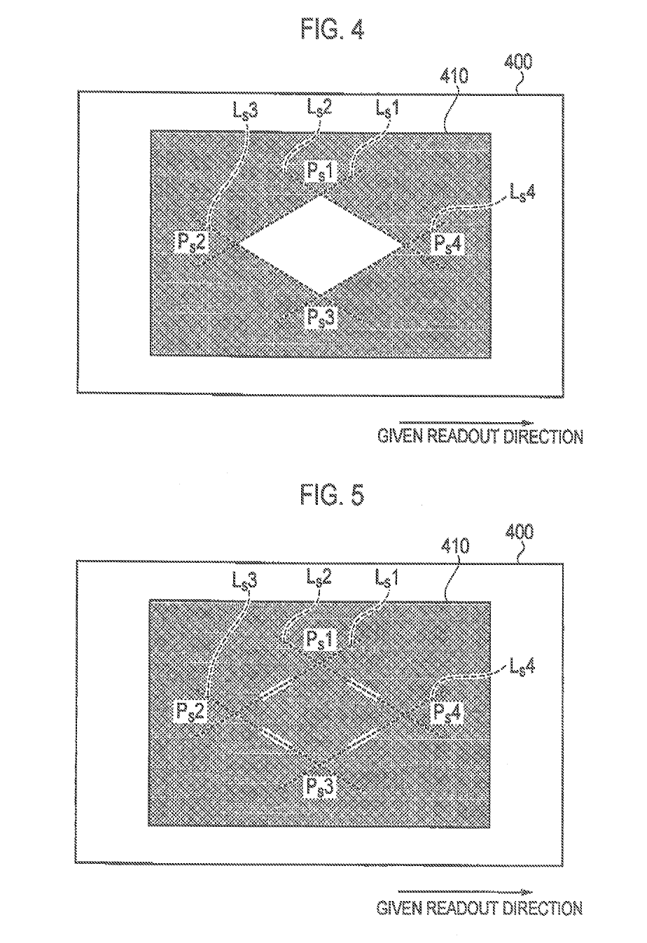

Examples of the test pattern image will be described below with reference to FIGS. 4 to 6. As shown in FIGS. 4 to 6, the test pattern image is formed of at least parts of four line segments (Lₛ1 to Lₛ4) defining four intersection points (Pₛ1 to Pₛ4). In the first embodiment, the four line segments (Lₛ1 to Lₛ4) are represented by the difference in shading or contrast (edge).

More specifically, the test pattern image may be an open rhombus on a black background, as shown in FIG. 4. Here, the four sides of the open rhombus form at least parts of the four line segments (Lₛ1 to Lₛ4). Each of the four line segments (Lₛ1 to Lₛ4) is inclined relative to the given readout direction (horizontal direction).

Alternatively, the test pattern image may be open line segments on a black background, as shown in FIG. 5. The open line segments form parts of the four sides of the open rhombus shown in FIG. 4. Here, the open line segments form at least parts of the four line segments (Lₛ1 to Lₛ4). Each of the four line segments (Lₛ1 to Lₛ4) is inclined relative to the given readout direction (horizontal direction).

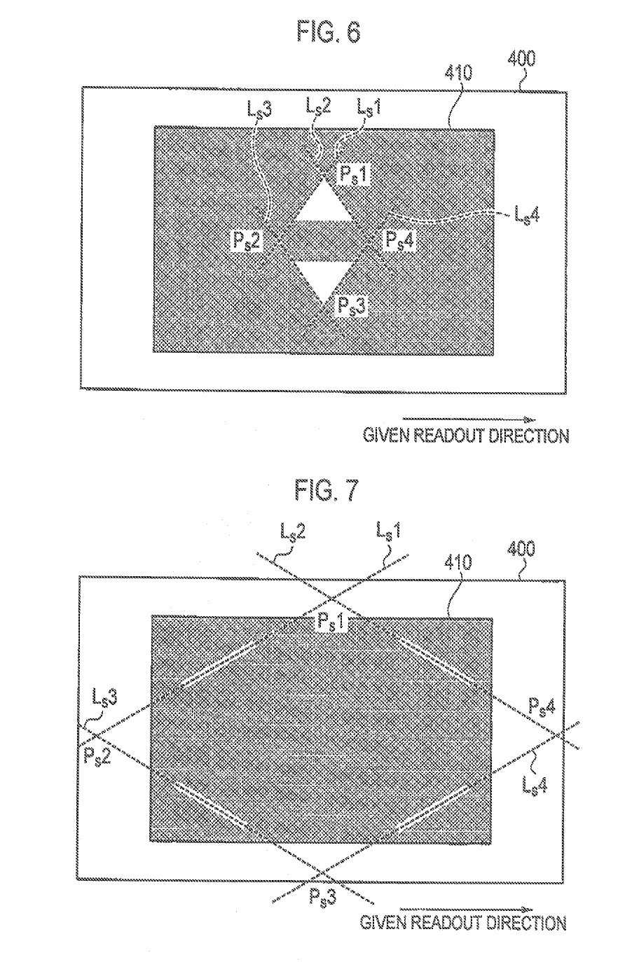

Still alternatively, the test pattern image may be a pair of open triangles on a black background, as shown in FIG. 6. Here, two sides of each of the pair of open triangles form at least parts of the four line segments (Lₛ1 to Lₛ4). Each of the four line segments (Lₛ1 to Lₛ4) is inclined relative to the given readout direction (horizontal direction).

Still alternatively, the test pattern image may be open line segments on a black background, as shown in FIG. 7. Here, the open line segments form at least parts of the four line segments (Lₛ1 to Lₛ4). As shown in FIG. 7, the four intersection points (Pₛ1 to Pₛ4) defined by the four line segments (Lₛ1 to Lₛ4) may be provided outside the projectable range 410. Each of the four line segments (Lₛ1 to Lₛ4) is inclined relative to the given readout direction (horizontal direction).

The readout unit 230 reads a shot image from the imaging device 300. More specifically, the readout unit 230 reads a shot image of the test pattern image from the imaging device 300 sequentially in the given readout direction for the test pattern image. To put it differently, the readout unit 230 includes a line buffer and, for each given line forming the test pattern image, the readout unit 230 reads data of the shot image corresponding to the given line into a line buffer, the shot image being imaged by the imaging device 300. It should be noted that the readout unit 230 thus requires no frame buffer.

The detection unit 240 firstly detects a display area provided on the projection plane 400. Here, the display area is defined by the outer frame of the screen or the like, as described above.

More specifically, the detection unit 240 only needs to be configured to detect the four corners of the display area. For example, the detection unit 240 detects the four corners of the display area on the basis of the shot age read by the readout unit 230 sequentially in the given readout direction.

The detection unit 240 secondly acquires three or more intersection points in the shot image on the basis of the shot image read by the readout unit 230 sequentially in the given readout direction.

More specifically, the detection unit 240 acquires the three or more intersection points in the shot image in accordance with the following procedure. Description is given here of a case where the test pattern image is the image shown in FIG. 4 (open rhombus).

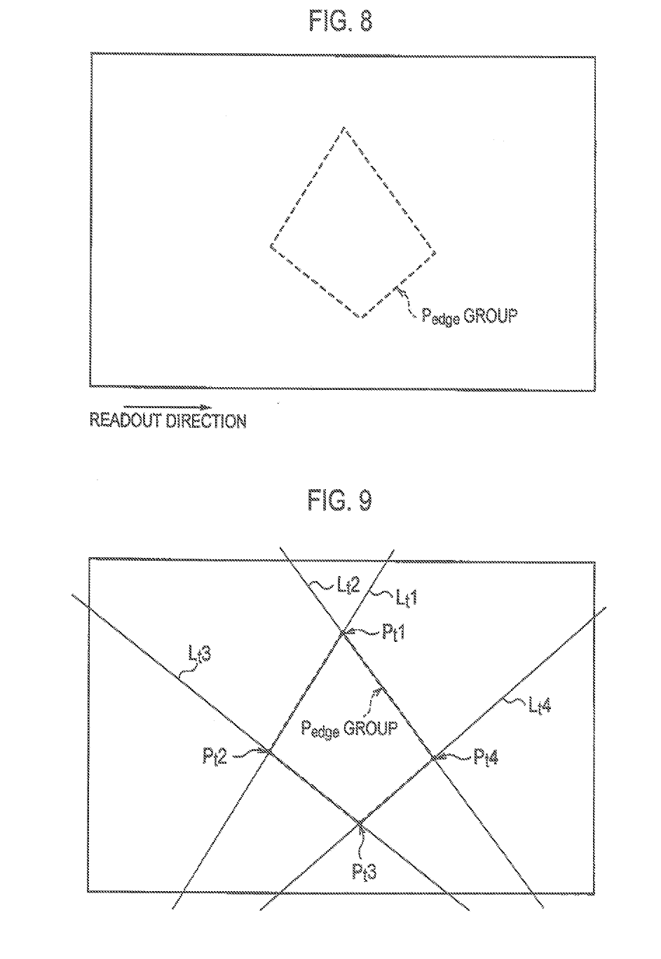

As shown in FIG. 8, the detection unit 240 firstly acquires points P_{edge} having the difference in shading or contrast (edge), on the basis of the shot image read into the line buffer by the readout unit 230. In other words, the detection unit 240 acquires a group of points P_{edge} corresponding to the four sides of the open rhombus of the test pattern image.

As shown in FIG. 9, the detection unit 240 secondly acquires four line segments (Lₜ1 to Lₜ4) in the shot image, on the basis of the group of points P_{edge}. In other words, the detection unit 240 acquires the four line segments (Lₜ1 to Lₜ4) corresponding to the four line segments (Lₛ1 to Lₛ4) in the test pattern image.

As shown in FIG. 9, the detection unit 240 thirdly acquires four intersection points (Pₜ1 to Pₜ4) in the shot image, on the basis of the four line segments (Lₜ1 to Lₜ4). In other words, the detection unit 240 acquires the four intersection points (Pₜ1 to Pₜ4) corresponding to the four intersection points (Pₛ1 to Pₛ4) in the test pattern image.

The calculation unit 250 calculates a positional relation between the projection display apparatus 100 and the projection plane 400, on the basis of three or more intersection points in the test pattern image (for example Pₛ1 to Pₛ4) and three or more intersection points in the shot image (for example Pₜ1 to Pₜ4). More specifically, the calculation unit 250 calculates the amount of deviation of the optical axis N of the projection display apparatus 100 (projection unit 110) from the normal M of the projection plane 400.

Note that, hereinafter, a test pattern image stored in the storage unit 220 is referred to as a stored test pattern image; a test pattern image included in a shot image is referred to as a shot test pattern image; a test pattern image projected on the projection plane 400 is referred to as a projected test pattern image.

The calculation unit 250 firstly calculates coordinates of four intersection points (Pᵤ1 to Pᵤ4) in the projected test pattern image. Description is given here taking as an example an intersection point Pₛ1 of the stored test pattern image, an intersection point Pₜ1 of the shot test pattern image, and an intersection point Pᵤ1 of the projected test pattern image. The intersection points Pₛ1, Pₜ1, and Pᵤ1 correspond to one another.

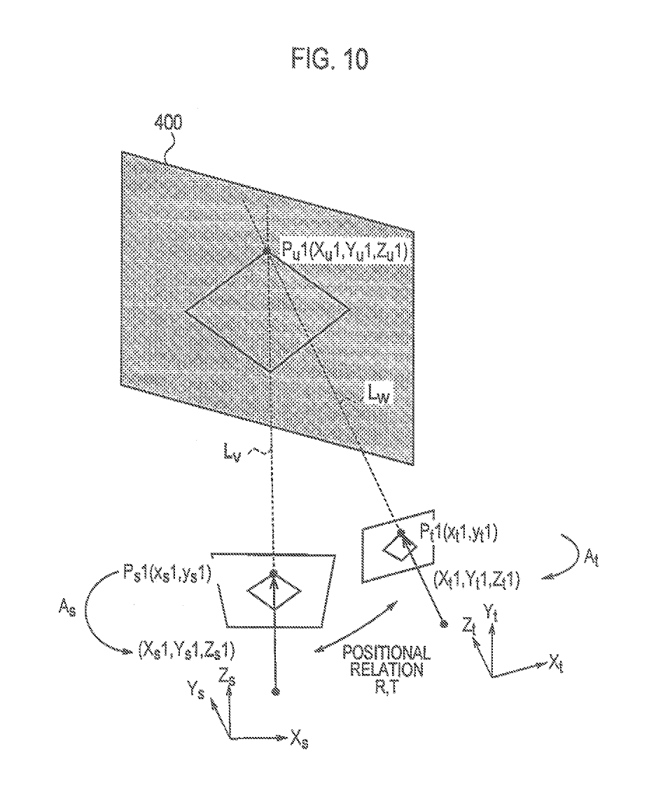

A method of calculating coordinates (Xᵤ1, Yᵤ1, Zᵤ1) of the intersection point Pᵤ1 will be described below with reference to FIG. 10. It should be noted that the coordinates (Xᵤ1, Yᵤ1, Zᵤ1) of the intersection point Pᵤ1 is in a three-dimensional space with a focal point Oₛ of the projection display apparatus 100 as its origin.

(1) The calculation unit 250 transforms coordinates (Xₛ1, Yₛ1) of the intersection point Pₛ1 in a two-dimensional plane of the stored test pattern image into coordinates (Xₛ1, Yₛ1, Zₛ1) of the intersection point Pₛ1 in the three-dimensional space with the focal point Oₛ of the projection display apparatus 100 as its origin. To be more specific, the coordinates (Xₛ1, Yₛ1, Zₛ1) of the intersection point Pₛ1 is represented by the following formula:

$$\begin{matrix}[ Formula 1 ] & \\ ( \begin{matrix}{X}_{s} 1 \\ {Y}_{s} 1 \\ {Z}_{s} 1\end{matrix} ) = As ( \begin{matrix}{x}_{s} 1 \\ {y}_{s} 1 \\ 1\end{matrix} ) , & Formula ( 1 )\end{matrix}$$

where As indicates a 3×3 transformation matrix and can be acquired in advance through preprocessing such as calibration. In other words, As is a known parameter.

Here, planes perpendicular to an optical axis direction of the projection display apparatus 100 are represented by an Xₛ axis and a Yₛ axis, and the optical axis direction of the projection display apparatus 100 is represented by a Zₛ axis.

Likewise, the calculation unit 250 transforms coordinates (Xₜ1, Y₁1) of the intersection point Pₜ1 in a two-dimensional plane of the shot test pattern image into coordinates (Xₜ1, Yₜ1, Zₜ1) of the intersection point Pₜ1 in a three-dimensional space with a focal point Oₜ of the imaging device 300 as its origin by using the following formula:

$$\begin{matrix}[ Formula 2 ] & \\ ( \begin{matrix}{X}_{t} 1 \\ {Y}_{t} 1 \\ {Z}_{t} 1\end{matrix} ) = At ( \begin{matrix}{x}_{t} 1 \\ {y}_{t} 1 \\ 1\end{matrix} ) , & Formula ( 2 )\end{matrix}$$

where At indicates a 3×3 transformation matrix and can be acquired in advance through preprocessing such as calibration. In other words, At is a known parameter.

Here, planes perpendicular to an optical axis direction of the imaging device 300 are represented by an Xₜ axis and an Yₜ axis, and a direction in which the imaging device 300 is directed (imaging direction) is represented by a Zₜ axis. It should be noted that inclination (vector) of the direction in which the imaging device 300 is directed (imaging direction) is known in the above coordinate space.

(2) The calculation unit 250 calculates a formula for a line Lᵥ connecting the intersection points Pₛ1 and Pᵤ1. Likewise, the calculation unit 250 calculates a formula for a line L_{w} connecting the intersection points Pₜ1 and Pᵤ1. The formulae for the lines Lᵥ and L_{w} are represented as follows:

$$\begin{matrix}[ Formula 3 ] & \\ {L}_{v} = ( \begin{matrix}{X}_{s} \\ {Y}_{s} \\ {Z}_{s}\end{matrix} ) = {K}_{s} ( \begin{matrix}{X}_{s} 1 \\ {Y}_{s} 1 \\ {Z}_{s} 1\end{matrix} ) , \\ and & Formula ( 3 ) \\ {L}_{w} = ( \begin{matrix}{X}_{t} \\ {Y}_{t} \\ {Z}_{t}\end{matrix} ) = {K}_{t} ( \begin{matrix}{X}_{t} 1 \\ {Y}_{t} 1 \\ {Z}_{t} 1\end{matrix} ) , & Formula ( 4 )\end{matrix}$$

where Kₛ and Kₜ are parameters.

The calculation unit 250 transforms the line L_{w} into a line L_{w}′ in the three-dimensional space with the focal point Oₛ of the projection display apparatus 100 as its origin. The line L_{w}′ is represented by the following formula:

$$\begin{matrix}[ Formula 4 ] & \\ {L}_{w}^{′} = ( \begin{matrix}{X}_{t}^{′} \\ {Y}_{t}^{′} \\ {Z}_{t}^{′}\end{matrix} ) = {K}_{t} R ( \begin{matrix}{X}_{t} 1 \\ {Y}_{t} 1 \\ {Z}_{t} 1\end{matrix} ) + T , & Formula ( 5 )\end{matrix}$$

Since the optical axis direction of the projection display apparatus 100 and the direction in which the imaging device 300 is directed (imaging direction) are known, a parameter R indicating a rotational component is known. Likewise, since the positions of the projection display apparatus 100 and the imaging device 300 relative to each other are known, a parameter T indicating a translational component is also known.

(4) The calculation unit 250 calculates the parameters Kₛ and Kₜ in the intersection point between the line Lᵥ and the line L_{w}′ (i.e., intersection point Pᵤ1) on the basis of the formulae (3) and (5). Then, the calculation unit 250 calculates the coordinates (Xᵤ1, Yᵤ1, Zᵤ1) of the intersection point Pᵤ1 on the basis of the coordinates (Xₛ1, Yₛ1, Zₛ1) of the intersection point Pₛ1 and Kₛ. Alternatively, the calculation unit 250 calculates the coordinates (Xᵤ1, Yᵤ1, Zᵤ1) of the intersection point Pᵤ1 on the basis of the coordinates (Xₜ1, Yₜ1, Zₜ1) of the intersection point Pₜ1 and Kₜ.

The calculation unit 250 thereby calculates the coordinates (Xᵤ1, Yᵤ1, Zᵤ1) of the intersection point Pᵤ1. In the same manner, the calculation unit 250 calculates the coordinates (Xᵤ2, Yᵤ2, Zᵤ2) of the intersection point Pᵤ2, the coordinates (Xᵤ3, Yᵤ3, Zᵤ3) of the intersection point Pᵤ3, and the coordinates (Xᵤ4, Yᵤ4, Zᵤ4) of the intersection point Pᵤ4.

The calculation unit 250 secondly calculates the normal M of the projection plane 400. More specifically, the calculation unit 250 calculates a vector of the normal M of the projection plane 400 by using the coordinates of at least three of the intersection points Pᵤ1 to Pᵤ4. When parameters k₁, k₂, and k₃ represent the vector of the normal M of the projection plane 400, a formula for the projection plane 400 is represented as follows:

[Formula 5]

k₁x+k₂y+k₃z+k₄=0 Formula (6),

where k₁, k₂, k₃, and k₄ are predetermined coefficients.

Thereby, the calculation unit 250 can calculate the amount of deviation of the optical axis N of the projection display apparatus 100 from the normal M of the projection plane 400. In other words, the calculation unit 250 can calculate the positional relation between the projection display apparatus 100 and the projection plane 400.

The projection unit controller 260 controls the projection unit 110. More specifically, the projection unit controller 260 is configured to control the lens group in the projection unit 110 to expand or shrink the projectable range 410 (image). The projection unit controller 260 is also configured to control the lens group in the projection unit 110 to move a position of the projectable range 410 (image) in the projection plane 400.

For example, the projection unit controller 260 controls the lens group in the projection unit 110 in response to an operation by the user using a user interface (not shown). The projection unit controller 260 thereby expands, shrinks, or moves the projectable range 410 (image).

The imager controller 270 converts an image input signal into an image output signal, and controls the liquid crystal panels 50 on the basis of the image output signal. The imager controller 270 further includes the following functions.

Firstly, the imager controller 270 functions to automatically correct the shape of an image projected on the projection plane 400, on the basis of the positional relation between the projection display apparatus 100 and the projection plane 400. In other words, the imager controller 270 functions to automatically perform keystone correction on the basis of the positional relation between the projection display apparatus 100 and the projection plane 400.

Secondly, the imager controller 270 controls the liquid crystal panels 50 in conjunction with the control on the projection unit 110. For example, the imager controller 270 controls the liquid crystal panels 50 in the following way.

The imager controller 270 controls the liquid crystal panels 50 so that the image projected on the projection plane 400 may fit within the projection frame, in conjunction with the movement of the position of the projectable range 410. More specifically, the imager controller 270 acquires the amount of movement of and a movement speed of the position of the projectable range 410 from the projection unit controller 260, and controls the liquid crystal panels 50 in accordance with the amount of movement and the movement speed thus acquired. For example, in a case where the projectable range 410 partly goes off the projection frame due to the movement of the projectable range 410, the imager controller 270 controls the liquid crystal panels 50 so that the position of the image may be moved within the projectable range 410, and thereby keeps the image within the projection frame.

Thirdly, the imager controller 270 controls the liquid crystal panels 50 so that an indicator may be displayed, the indicator indicating a direction in which the image projected on the projection plane 400 is movable in the projection frame. For example, the indicator is an arrow or the like indicating a horizontal direction or vertical direction in which the image is movable in the projection frame. Alternatively, the indicator may be an arrow or the like indicating an oblique direction in which the image is movable in the projection frame.

(Display Example of Indicator)

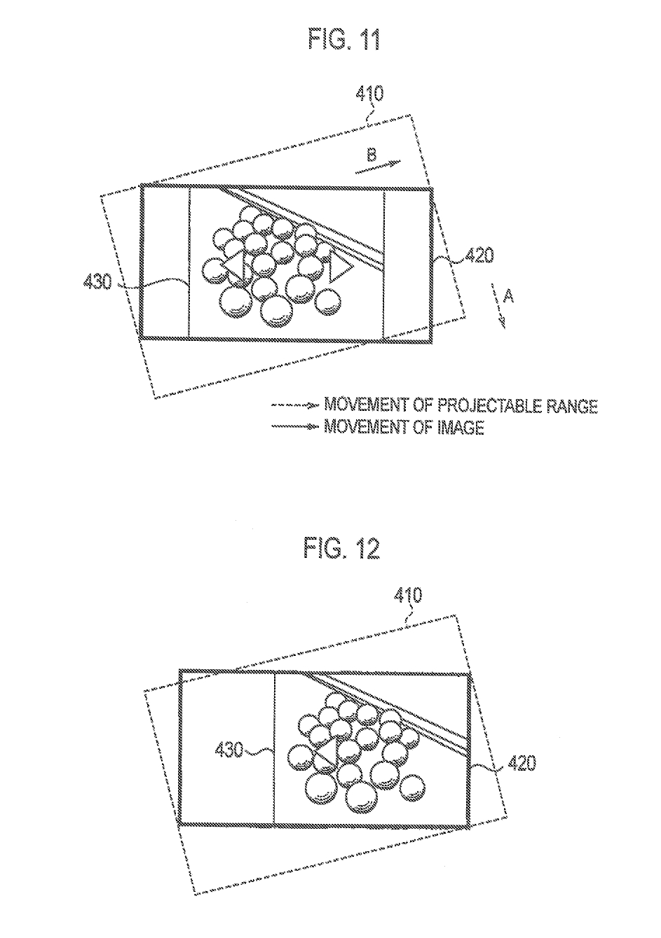

Display examples of the indicator according to the first embodiment will be described below with reference to the drawings. FIGS. 11 and 12 are views showing the display examples of the indicator according to the first embodiment.

As shown in FIG. 11, the projectable range 410 and a projection frame 420 include an overlap region, and an image 430 is displayed in the overlap region. The image 430 is located at substantially the center of the projectable range 410, and is located at substantially the center of the projection frame 420.

When the image 430 is located at substantially the center of the projection frame 420, the image 430 is movable to the left and to the right. Thus, an indicator indicating that the image 430 is movable to the left and an indicator indicating that the image 430 is movable to the right are displayed.

Now consider a case where the user gives an instruction to move the image 430 to the right in the projection frame 420 through the user interface or the like.

In the first embodiment, as shown in FIGS. 11 and 12, the projection unit controller 260 controls the projection unit 110 so that the position of the projectable range 410 may be moved in a lower right direction A. In the meanwhile, the imager controller 270 controls the liquid crystal panels 50 so that the display position of the image 430 may be moved in an upper right direction B in the projectable range 410 in conjunction with the movement of the position of the projectable range 410.

On the other hand, consider a case where the user gives an instruction to move the image 430 to the left in the projection frame 420 through the user interface or the like. In this case, having no need to move the projectable range 410, the imager controller 270 controls the liquid crystal panels 50 so that the display position of the image 430 may be moved to the left in the projectable range 410 independently even though the position of the projectable range 410 is not moved.

(Operation of Projection Display Apparatus)

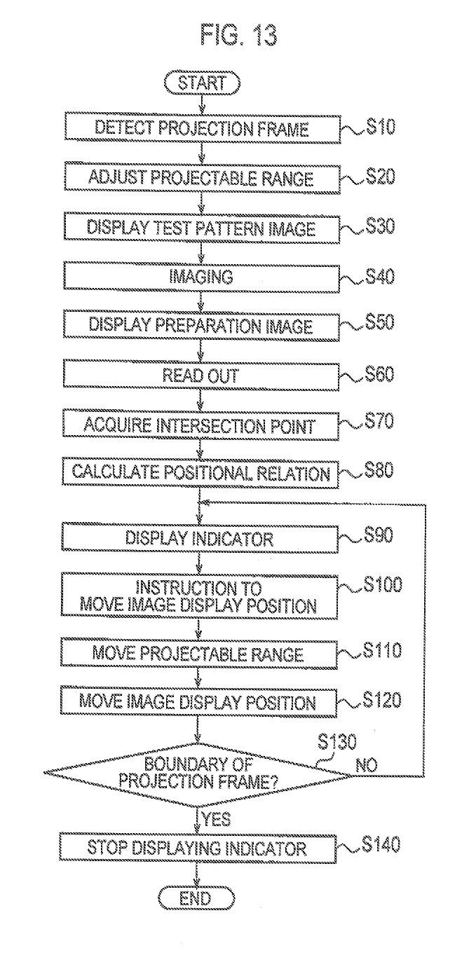

An operation of the projection display apparatus (control unit) according to the first embodiment will be described below with reference to the drawing. FIG. 13 is a flowchart showing the operation of the projection display apparatus 100 (control unit 200) according to the first embodiment.

As shown in FIG. 13, in Step 10, the projection display apparatus 100 detects the projection frame 420. For example, the projection display apparatus 100 detects the projection frame 420 on the basis of imaging data of the imaging device 300.

In Step 20, the projection display apparatus 100 controls the projection unit 110 to adjust the position of the projectable range 410 so that the projectable range 410 and the projection frame 420. Note that, the image 430 is included in the overlap region of the projectable range 410 and the projection frame 420, as a matter of course.

In Step 30, the projection display apparatus 100 displays a test pattern image. More specifically, the projection display apparatus 100 projects the test pattern image on the projection plane 400 by the control on the liquid crystal panels 50 and the like.

In Step 40, the imaging device 300 provided to the projection display apparatus 100 images the projection plane 400. More specifically, the imaging device 300 images the test pattern image projected on the projection plane 400.

In Step 50, the projection display apparatus 100 displays a preparation image. More specifically, the projection display apparatus 100 projects the preparation image on the projection plane 400 by the control on the liquid crystal panels 50 and the like.

Here, the preparation image may be a blue screen image or a black screen image, for example.

In Step 60, the projection display apparatus 100 reads the shot image of the test pattern image from the imaging device 300 sequentially in a given readout direction for the test pattern image. More specifically, for each given line forming the test pattern image, the projection display apparatus 100 reads data of the shot image corresponding to the given line into a line buffer, the shot image being imaged by the imaging device 300.

In Step 70, the projection display apparatus 100 acquires three or more intersection points in the shot image (for example Pₜ1 to Pₜ4 in FIG. 9) on the basis of the shot image sequentially read in the given readout direction.

In Step 80, the projection display apparatus 100 calculates a positional relation between the projection display apparatus 100 and the projection plane 400 on the basis of four intersection points in the test pattern image (Pₛ1 to Pₛ4) and the four intersection points in the shot image (Pₜ1 to Pₜ4).

In Step 90, the projection display apparatus 100 displays an indicator indicating a direction in which the image projected on the projection plane 400 is movable in the projection frame 420. In other words, the projection display apparatus 100 projects the indicator by the control on the liquid crystal panels 50.

In Step 100, the projection display apparatus 100 receives an operation by the user giving an instruction to move the image 430 using the user interface.

In Step 110, the projection display apparatus 100 controls the projection unit 110 so that the projectable range 410 may be moved to such a position that the image 430 moved in the direction instructed through the user's operation is included in the overlap region of the projectable range 410 and the projection frame 420.

In Step 120, the projection display apparatus 100 controls the liquid crystal panels 50 so that the image projected on the projection plane 400 may fit within the projection frame 420, in conjunction with the movement of the position of the projectable range 410.

Note that, it is preferable to perform the processes of Step 110 and Step 120 at the same time so that the image 430 may be smoothly moved in the direction instructed through the user's operation while the image 430 is kept within the projection frame 420. In other words, it is preferable to perform the processes of Step 110 and Step 120 at the same time so as not to make the user feel odd.

In Step 130, the projection display apparatus 100 judges whether or not the image 430 has reached the projection frame 420. If the image 420 has reached the projection frame 420, the projection display apparatus 100 proceeds to a process of Step 140. If the image 420 has not reached the projection frame 420 yet, the projection display apparatus 100 goes back to the process of Step 90.

In Step 140, the projection display apparatus 100 stops displaying the indicator. For example, when the image 430 has reached the left edge of the projection frame 420, the projection display apparatus 100 stops displaying the indicator indicating that the image 430 is movable to the left; when the image 430 has reached the right edge of the projection frame 420, the projection display apparatus 100 stops displaying the indicator indicating that the image 430 is movable to the right.

(Operation and Effect)

According to the first embodiment, the imager controller 270 controls the liquid crystal panels 50 so that the image 430 projected on the projection plane 400 may fit within the projection frame 420, in conjunction with the movement of the position of the projectable range 410. Accordingly, the display position of the image 430 projected on the projection plane 400 can be changed flexibly.

It should be noted that only the position of the image 430 needs to be moved in the projectable range 410 if the position of the projectable range 410 does not need to be moved.

In the first embodiment, the imager controller 270 controls the liquid crystal panels 50 so that the liquid crystal panels 50 may display the indicator indicating a direction in which the image 430 is movable in the projection frame 420. Accordingly, the user can easily move the display position of the image 430 projected on the projection plane 400.

Note that, since the image 430 is moved in the projectable range 410 in conjunction with the movement of the position of the projectable range 410, the image 430 can be moved in the projection frame 420 even if the projectable range 410 does not overlap the entire projection frame 420. Further, even if the projection unit 110 is controlled to move the projectable range 410 in a direction other than the horizontal direction or vertical direction, the image 430 can be moved in the projection frame 420.

### First Modified Example

A first modified example of the first embodiment will be described below with reference to the drawings. In the following, description will be mainly given of a difference from the first embodiment.

To be more specific, in the first modification example, the imager controller 270 controls the liquid crystal panels 50 in conjunction with the expansion or shrinkage of the projectable range 410 in the following way.

Firstly, in conjunction with the shrinkage of the projectable range 410, the imager controller 270 causes the position of the image 430 projected on the projection plane 400 to move in the projectable range 410 without changing the center position of the image 430 in the projection plane 400. More specifically, the imager controller 270 acquires the amount of shrinkage and a shrinkage speed of the projectable range 410 from the projection unit controller 260, and controls the liquid crystal panels 50 in accordance with the amount of shrinkage and the shrinkage speed thus acquired.

Secondly, in conjunction with the expansion of the projectable range 410, the imager controller 270 causes the position of the image 430 projected on the projection plane 400 to move in the projectable range 410 without changing the center position of the image 430 in the projection plane 400. More specifically, the imager controller 270 acquires the amount of expansion and an expansion speed of the projectable range 410 from the projection unit controller 260, and controls the liquid crystal panels 50 in accordance with the amount of expansion and the expansion speed thus acquired.

For example, if the projectable range 410 is expanded or shrunk in a state where the center position of the projectable range 410 is displaced from the center position of the image 430, the position of the image 430 is shifted in the projection frame 420. To cope with this case, the imager controller 270 controls the liquid crystal panels 50 so that the position of the image 430 may be moved in the projectable range 410, without changing the center position of the image 430 projected on the projection plane 400.

(Example of Shrinking Image)

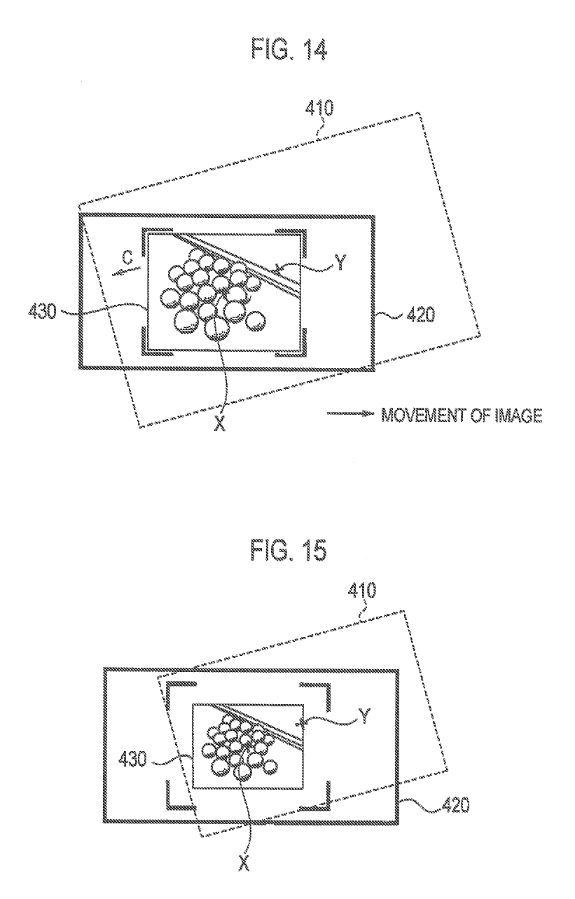

An example of shrinking an image according to the first modification example will be described below with reference to the drawings. FIGS. 14 and 15 are views showing the example of shrinking an image according to the first modification example.

As shown in FIG. 14, a center X of the image 430 is displaced leftward and downward from a center Y of the projectable range 410. If the projectable range 410 is shrunk in such a case, the position of the image 430 shifts rightward and upward in the projection frame 420.

In the first modification example, as shown in FIGS. 14 and 15, the imager controller 270 controls the liquid crystal panels 50 so that the image 430 may be moved in a lower left direction C in the projectable range 410 in conjunction with the shrinkage of the projectable range 410, without changing the center position of the image 430.

(Example of Expanding Image)

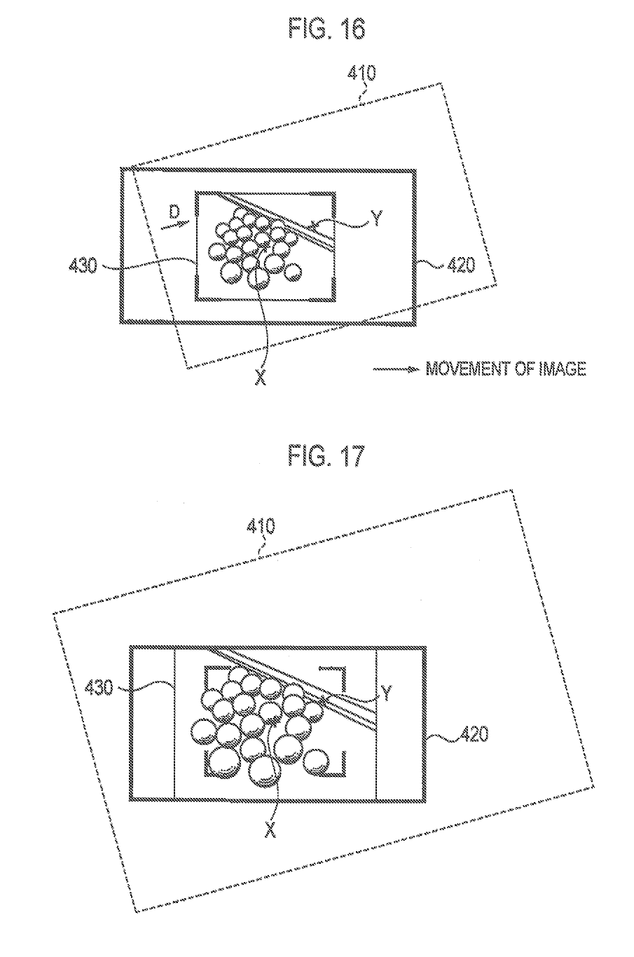

An example of expanding an image according to the first modification example will be described below with reference to the drawings. FIGS. 16 and 17 are views showing the example of expanding an image according to the first modification example.

As shown in FIG. 16, a center X of the image 430 is displaced leftward and downward relative to a center Y of the projectable range 410. If the projectable range 410 is expanded in such a case, the position of the image 430 shifts leftward and downward in the projection frame 420.

In the first modification example, as shown in FIGS. 16 and 17, the imager controller 270 controls the liquid crystal panels 50 so that the image 430 may be moved in an upper right direction D in the projectable range 410 in conjunction with the expansion of the projectable range 410, without changing the center position of the image 430.

Note that, in the first modification example, description has been given of the case of shrinking or expanding the projectable range 410 while not changing the position of the projectable range 410; however, it is also possible to shrink or expand the projectable range 410 while changing the position of the projectable range 410, as a matter of course.

(Operation and Effect)

According to the first modification example, the imager controller 270 moves the position of the image 430 in the projectable range 410 in conjunction with the shrinkage or expansion of the projectable range 410, without changing the center position of the image 430. Since the center position of the image 430 is kept in this way, the image 430 can be shrunk or expanded at a position desired by the user.

### Second Modified Example

A second modified example of the first embodiment will be described below with reference to the drawings. In the following, description will be mainly given of a difference from the first embodiment.

Specifically, in the second modified example, the imager controller 270 controls the liquid crystal panels 50 so that the liquid crystal panels 50 may display a candidate position at which the image 430 projected on the projection plane 400 is displayable in the projection frame 420. The candidate position is represented by surrounding a candidate region, in which the image 430 is displayable, with a dotted line.

(Example of Displaying Candidate Position)

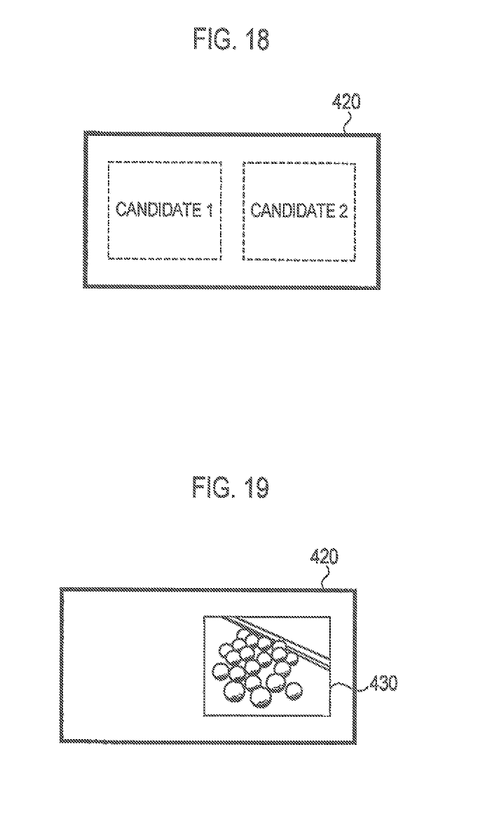

An example of displaying a candidate position according to the second modification example will be described below with reference to the drawings. FIGS. 18 and 19 are views showing the example of displaying a candidate position according to the second modification example.

As shown in FIG. 18, multiple candidate positions (candidates 1 and 2 in this example) are displayed as a candidate position at which the image 430 is displayable in the projection frame 420.

Now consider a case where the user gives an instruction to select the candidate 2 through the user interface or the like.

In the second modification example 2, as shown in FIGS. 18 and 19, the image 430 is displayed at the candidate 2 in the projection frame 420.

(Operation and Effect)

According to the second modified example, the imager controller 270 controls the liquid crystal panels 50 so that the liquid crystal panels 50 may display a candidate position at which the image 430 projected on the projection plane 400 is displayable in the projection frame 420. Accordingly, the user can easily move the image 430 in the projection frame 420.

Moreover, since the candidate position is determined in advance, the projection display apparatus 100 can also execute calculation processing in advance. This helps to move the display position of the image 430 swiftly.

### Third Modified Example

A third modified example of the first embodiment will be described below with reference to the drawings. In the following, description will be mainly given of a difference from the first embodiment.

Specifically, in the third modification example, the detection unit 240 detects the projection frame 420 by detecting a detection target provided on the projection plane 400.

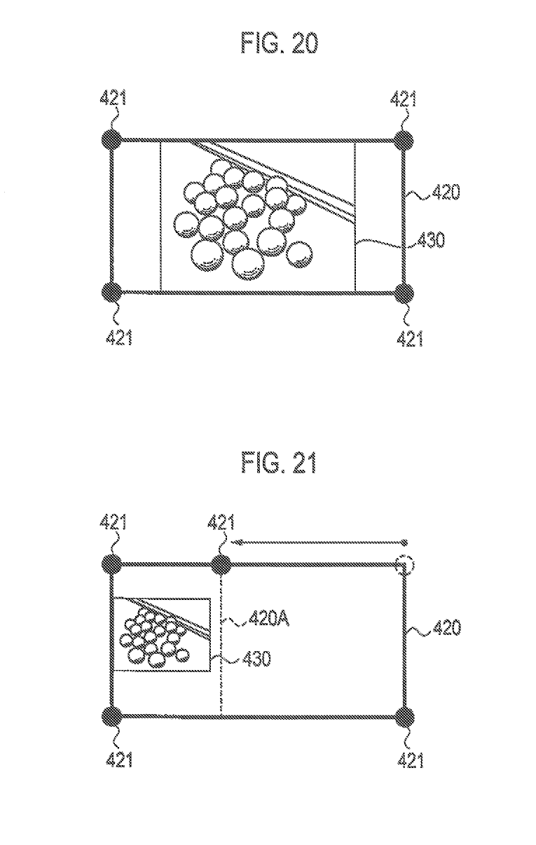

For example, as shown in FIG. 20, the detection unit 240 detects four detection targets 421 provided on the projection plane 400. The detection unit 240 thereby detects the four corners of the projection frame 420.

Here, it is also conceivable that a region surrounded by the four detection targets 421 is not a rectangle formed of a pair of sides extending in the horizontal direction and a pair of sides extending in the vertical direction (hereinafter called a rectangular projection frame). In this case, the detection unit 240 detects, as the projection frame 420, the largest possible rectangular projection frame in the region surrounded by the four detection targets 421.

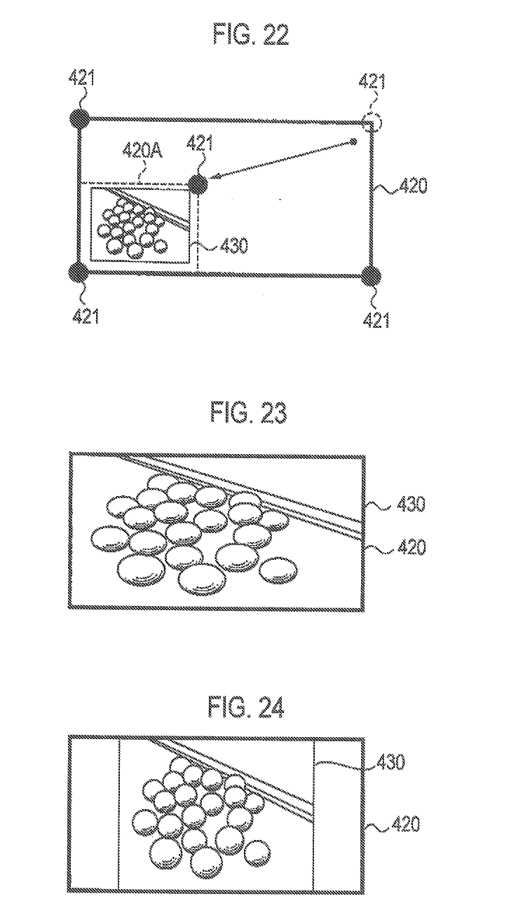

For example, as shown in FIGS. 21 and 22, if the user moves one of the detection targets 421, the detection unit 240 detects, as the projection frame 420, the largest possible rectangular projection frame in a region surrounded by the four detection targets 421.

Note that, the detection targets 421 may be markers provided on the projection plane 400. In this case, the projection frame 420 is detected by the detection of the markers. For example, in a case where four markers are provided, the largest possible rectangular projection frame in a region surrounded by the four markers is detected as the projection frame 420. Further, in a case where two markers are provided, among four sides included in the projection frame 420, the two sides having an intersection point are detected by one marker, whereas the other two sides having an intersection point are detected by the other marker.

Alternatively, the detection targets 421 may be spot light beams applied onto the projection plane 400 from a laser pointer or an infrared pointer. In this case, the size of the projection frame 420 is changed with the movement of the spot light beams, as shown in FIGS. 21 and 22.

Still alternatively, the detection targets 421 may be hands of the user or the like. In this case, the size of the projection frame 420 is changed with the movement of the hands of the user or the like, as shown in FIGS. 21 and 22.

Still alternatively, the detection targets 421 may be a paper sheet provided on the projection plane 400. In this case, the outer frame of the paper sheet is detected as the projection frame 420.

Still alternatively, the detection targets 421 may be a frame border drawn on the projection plane 400. In this case, the frame border is detected as the projection frame 420.

(Operation and Effect)

In the third modification example, the detection unit 240 detects the projection frame 420 by detecting the detection targets 421 provided on the projection plane 400. Accordingly, the detection of the projection frame 420 is easy. Moreover, the size of the projection frame 420 can be changed easily by the movement of the detection targets 421 or the like.

### Fourth Modified Example

A fourth modified example of the first embodiment will be described below with reference to the drawings. In the following, description will be mainly given of a difference from the first embodiment.

Specifically, in the fourth modified example, the imager controller 270 controls the liquid crystal panels 50 so that the aspect ratio of the image 430 may be adjusted in accordance with the projection frame 420.

(Example of Adjusting Aspect Ratio)

An example of adjusting an aspect ratio according to the fourth modified example will be described below with reference to the drawings. FIGS. 23 and 24 are views showing the example of adjusting the aspect ratio according to the fourth modified example.

In a case where the setting is made such that the image 430 may be displayed across the entire projection frame 420 as shown in FIG. 23, the image 430 is not displayed according to its original aspect ratio, but is displayed while being stretched or compressed in the horizontal direction or vertical direction.

Meanwhile, in a case where the setting is made such that the image 430 may be displayed according to its original aspect ratio as shown in FIG. 24, the image 430 is expanded or shrunk to fit within the projection frame 420.

Note that, it is preferable that the user can set the method of displaying the image 430 in the projection frame 420 (aspect ratio) as desired through the user interface or the like.

(Operation and Effect)

According to the fourth modified example, the imager controller 270 controls the liquid crystal panels 50 so that the aspect ratio of the image 430 may be adjusted in accordance with the projection frame 420. Accordingly, a desired aspect ratio can be easily achieved.

### Fifth Modified Example

A fifth modified example of the first embodiment will be described below with reference to the drawing. In the following, description will be mainly given of a difference from the first embodiment.

Specifically, in the fifth modified example, the imager controller 270 lets the user select whether to adjust the aspect ratio of the image 430 in accordance with the projection frame 420.

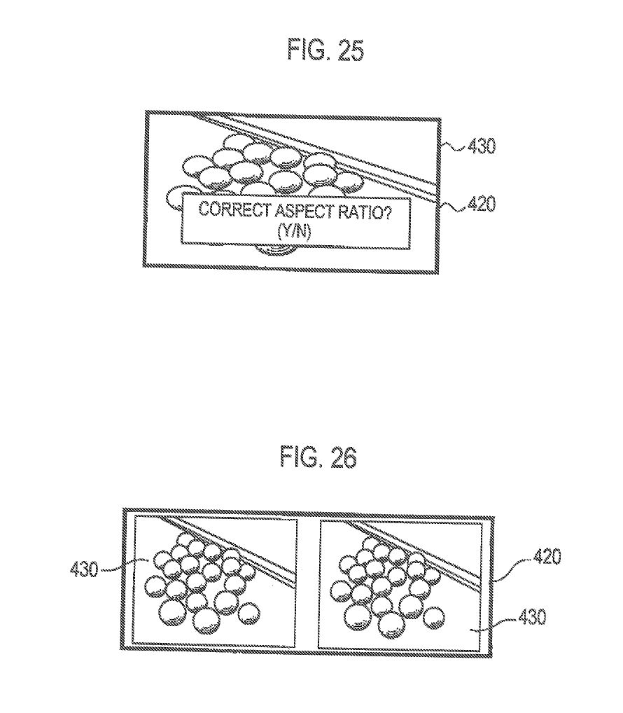

An example of adjusting an aspect ratio according to the fifth modified example will be described below with reference to the drawing. FIG. 25 is a view showing an example of a display for selection on whether the aspect ratio needs to be adjusted, according to the fifth modified example.

As shown in FIG. 25, in a case where the setting is made such that the image 430 may be displayed according to the aspect ratio of the projection frame 420, it is necessary to change the aspect ratio of the image 430 significantly instead of displaying the image 430 according to its original aspect ratio. In this case, an image for letting the user select whether the aspect ratio needs to be corrected is displayed to overlap with the projected image. The user gives an instruction to the projection display apparatus 100 on whether the aspect ratio needs to be adjusted, in response to the instruction displayed to overlap with the projected image.

Note that, it is preferable to adjust the aspect ratio of the image 430 without displaying the image for letting the user select whether the aspect ratio needs to be corrected so as to overlap with the projected image, in a case where the aspect ratio of the projection frame 420 and the original aspect ratio of the image 430 are almost equal to each other.

(Operation and Effect)

According to the fifth modified example, the image for letting the user select whether the aspect ratio needs to be corrected is displayed to overlap with the projected image, in order to let the user select whether the aspect ratio needs to be adjusted. This allows the user to determine whether the aspect ratio needs to be adjusted in accordance with the image 430 to be displayed, and thus prevents the user from viewing the image with the aspect ratio significantly different from its original aspect ratio.

### Sixth Modified Example

A sixth modified example of the first embodiment will be described below with reference to the drawings. In the following, description will be mainly given of a difference from the first embodiment.

Specifically, in the sixth modified example, the imager controller 270 displays multiple images 430 in accordance with the projection frame 420.

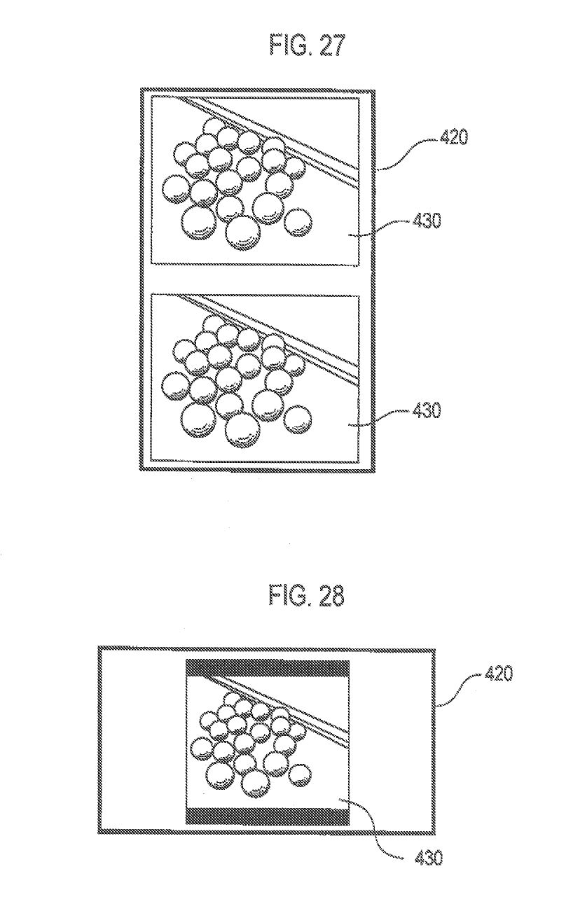

An example of displaying the multiple images 430 according to the sixth modified example will be described below with reference to the drawings. FIGS. 26 and 27 are views showing the example of displaying the multiple images 430 according to the sixth modified example.

As shown in FIGS. 26 and 27, a region of the projection frame 420 where no image is displayed is sometimes large when the image 430 is displayed in the projection frame 420 according to its original aspect ratio. To be more specific, FIG. 26 shows an example of a case where the length of the projection frame 420 in a lateral direction is two or more times larger than the length of the image 430 in the lateral direction. In this case, two images 430 are displayed in the lateral direction. On the other hand, FIG. 27 shows an example of a case where the length of the projection frame 420 in a vertical direction is two or more times larger than the length of the image 430 in the vertical direction. In this case, two images 430 are displayed in the vertical direction.

Note that, although the images 430 of the same size are arranged in the lateral direction or vertical direction in the sixth modified example, the present invention is not limited to this. Instead, two images may be displayed in the lateral direction or vertical direction with one of the images shrunk.

Further, although the same images 430 are arranged in the lateral direction or vertical direction in the sixth modified example, the present invention is not limited this. If two different image signals are inputted to the projection display apparatus 100, different images may be arranged in the lateral direction or vertical direction.

Further, the number of images 430 arranged is not limited to two. If the length of the projection frame 420 in the lateral direction or vertical direction is N (N is a positive integer) or more times larger than the length of the image 430 in the lateral direction or vertical direction, N images 430 may be displayed in the lateral direction or vertical direction.

(Operation and Effect)

According to the sixth modified example, two or more images 430 are displayed if two or more images 430 can be displayed in the projection frame 420 according to the original aspect ratio of the image 430. Accordingly, even if a region of the projection frame 420 where no image is displayed is large when the image 430 is displayed in the projection frame 420 according to its original aspect ratio, such region can be effectively used.

### Seventh Modified Example

A seventh modified example of the first embodiment will be described below with reference to the drawings. In the following, description will be mainly given of a difference from the first embodiment.

Specifically, in the seventh modified example, the imager controller 270 readjusts the size of the image 430 in response to change of the aspect ratio of the image 430 during projection.

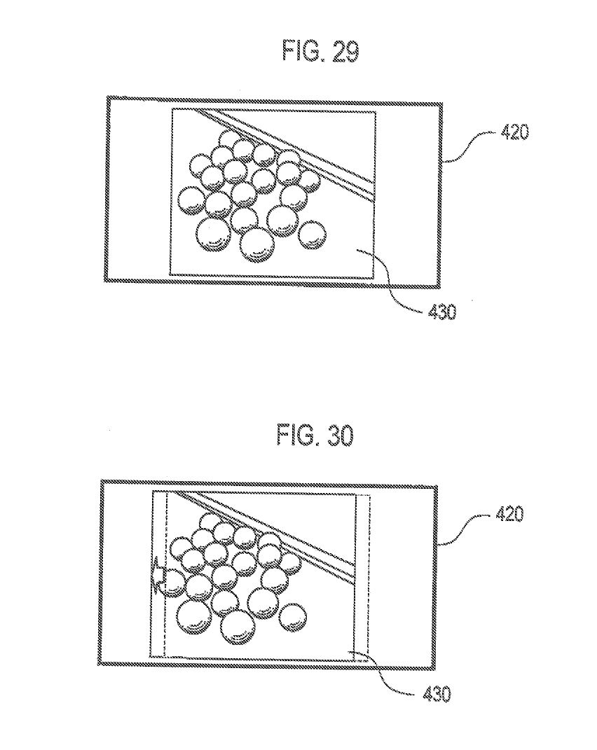

An example of readjusting the aspect ratio according to the seventh modified example will be described with reference to the drawings. FIGS. 28 and 29 are views showing an example where the imager controller 270 readjusts the size of the image 430 in response to an event where the aspect ratio of the image 430 is changed during projection.

Assume a case where the original aspect ratio of the image 430 is changed while the image 430 is projected, due to a change in the contents of the image or the like. In this case, if the aspect ratio is adjusted while the size of the image prior to the change in the original aspect ratio is kept, portions above and below the image 430 have to be displayed in black, as shown in FIG. 28.

In the seventh modified example, instead of displaying the portions above and below the image 430 in black, a display region optimum for the projection frame 420 is recalculated in the calculation unit 250 when the original aspect ratio of the image 430 is changed. Then, the imager controller 270 readjusts the image 430 in accordance with this recalculation result (see FIG. 29).

Note that, what is needed in the seventh modified example is only to recalculate the display region optimum for the projection frame 420 in the calculation unit 250 and not to re-detect the projection frame 420, as a matter of course.

(Operation and Effect)

According to the seventh modified example, the display region optimum for the projection frame 420 is recalculated in the calculation unit 250 when the original aspect ratio of the image 430 is changed. Accordingly, the image 430 can be displayed with an optimum display size even when the original aspect ratio of the image 430 is changed. Moreover, since the re-detection of the projection frame 420 is not required in the change of the aspect ratio, execution time can be shortened.

### Eighth Modified Example

An eighth modified example of the first embodiment will be described below with reference to the drawings. In the following, description will be mainly given of a difference from the first embodiment.

Specifically, in the eighth modified example, there are multiple operation modes different in the amount of movement of the image 430 in the movement thereof to the left or right.

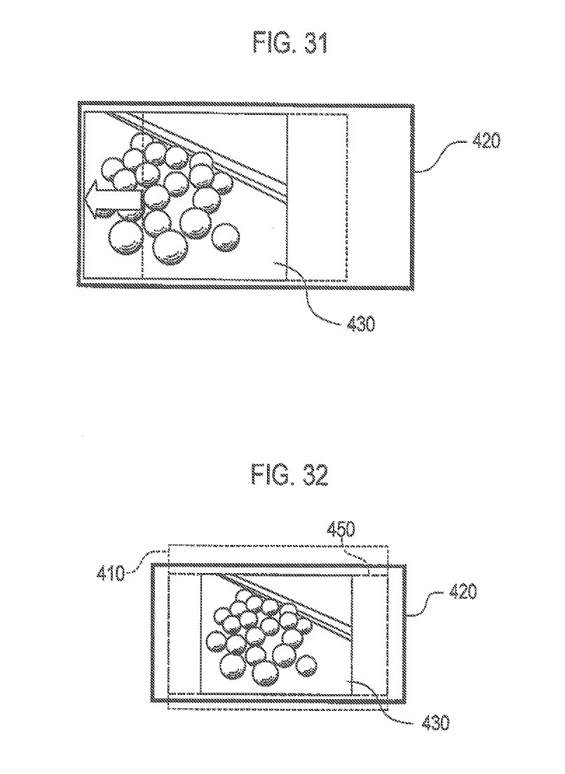

An example of operation modes different in the amount of movement according to the eighth modified example will be described with reference to the drawings. FIGS. 30 and 31 show the example of operation modes different in the amount of movement according to the eighth modified example.

A first operation mode example will be described. When the image 430 is moved to the left or right, the image 430 is moved to the left or right by a certain proportion of the length of the image 430 in the lateral direction, as shown in FIG. 30. For example, given a length equal to one-tenth of the length of the image 430 in the lateral direction is the certain proportion, the image 430 is moved to the left or right with the length equal to one-tenth of the length of the image 430 in the lateral direction used as one step.

A second operation mode example will be described. When the image 430 is moved to the left or right, the image 430 is moved to the edge of the projectable range at one time, as shown in FIG. 31.

The operation mode is switched between the above two modes in accordance with the length of depression of a certain key (for example a direction key) by the user. More specifically, the image 430 is moved to the left or right by the certain proportion of the length of the image in the lateral direction when a direction key is depressed for a short period of time; the image 430 is moved to the edge of the projectable range at one time when the direction key is depressed for a long period of time.

(Operation and Effect)

The eighth modified example includes the two operation modes of moving the image 430 to the left or right by the certain proportion of the length of the image 430 in the lateral direction and of moving the image 430 to the edge of the projectable range at one time. Accordingly, the image 430 can be swiftly moved to a movement destination of the image 430 desired by the user.

Note that, although the operation mode is switched between the two modes in accordance with the length of depression of the direction key in the eighth modified example, the present invention is not limited to this. Alternatively, the operation mode may be switched between the two modes by depressing a direction key other than the direction key indicating the movement direction. Still alternatively, the image 430 may be moved to the edge of the projectable range at one time by continuously depressing the direction key twice.

### Ninth Modified Example

A ninth modified example of the first embodiment will be described below with reference to the drawing. In the following, description will be mainly given of a difference from the first embodiment.

Specifically, in the ninth modified example, once the user operates a button to move the image 430, a movable range 450 is displayed to overlap with the projected image in order to let the user know the movable range 450 of the image 430.

An example of displaying the movable range 450 of the image 430 according to the ninth modified example will be described below with reference to the drawing. FIG. 32 is a view showing the example of displaying the movable range 450 of the image 430 according to the ninth modified example.

As shown in FIG. 32, upon detection of a button operation for moving the image 430 by the user, the calculation unit 250 determines a range within the projectable range 410 and within the projection frame 420 as the movable range 450. The imager controller 270 displays the movable range 450 determined by the calculation unit 250 with a dotted line so that the movable range 450 may overlap with the image 430.

(Operation and Effect)

According to the ninth modified example, the range within the projectable range 410 and within the projection frame 420 is determined as the movable range 450, and the movable range 450 thus determined is displayed with a dotted line to overlap with the image 430. This allows the user to check whether the image 430 is movable to a position desired by the user as soon as the user operates a button.

### Tenth Modified Example

A tenth modified example of the first embodiment will be described below with reference to the drawing. In the following, description will be mainly given of a difference from the first embodiment.

Specifically, in the tenth modified example, if the user wants to further move the image 430 beyond a movable limit of the image 430 when the image 430 reaches the movable limit, the image 430 is trimmed so that a region of the projection frame 420 where no image is projected may be increased.

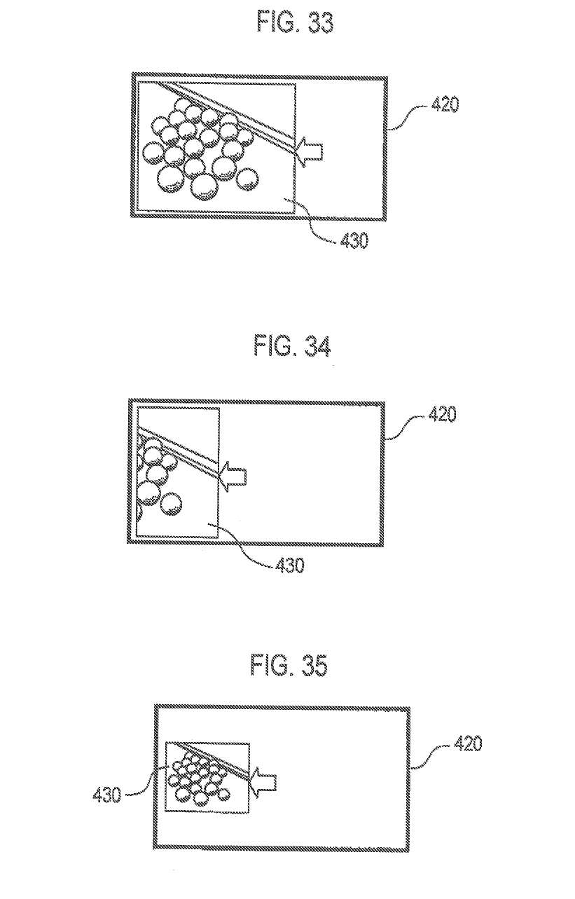

An example where the user moves the image 430 beyond the movable limit of the image 430 according to the tenth modified example will be described below with reference to the drawings. FIGS. 33 and 34 are views showing a case where the user moves the image 430 beyond the movable limit according to the tenth modified example.

FIG. 33 shows a state where the image 430 has reached its movable limit (in this example, description is given of a case where the movable limit is equal to the edge of the projection frame 420). If the user gives an instruction to further move the image 430 beyond the movable limit through a button operation in this state, a left part of the image 430 that extends off the projection frame 420 is trimmed as shown in FIG. 34.

(Operation and Effect)

The tenth modified example is effective for example in a case where the user wants to use the non-projected region of the projection frame 420 which is increased by moving the image 430. According to the tenth modified example, the user can increase the non-projected region of the projection frame 420 by further operating the button in the state where the image 430 has reached its movable limit. Accordingly, when the user makes a presentation while projecting the image 430 on a whiteboard or the like, the tenth modified example is effective in writing detailed description in a region of the whiteboard where no image is projected, for example.

Note that, a configuration for writing detailed description on a whiteboard or the like is not limited to the configuration described in the tenth modified example. For example, as shown in FIG. 35, the non-projected region of the projection frame 420 may be increased by shrinking the image 430.

Alternatively, the written contents may be highlighted in the writing of the detailed description by projecting the image 430 on the projection frame 420 while making the image 430 translucent.

### Eleventh Modified Example

An eleventh modified example of the first embodiment will be described below with reference to the drawing. In the following, description will be mainly given of a difference from the first embodiment.

Specifically, in the eleventh modified example, when the image 430 is moved by an operation of direction keys of a remote controller 500, a direction in which the image 430 is moved by operating the remote controller 500 from a projection side of (i.e., from a position anterior to) the projection display apparatus 100 is opposite to a direction in which the image 430 is moved by operating the remote controller 500 from a side opposite to the projection side (i.e. from a position posterior to) the projection display apparatus 100.

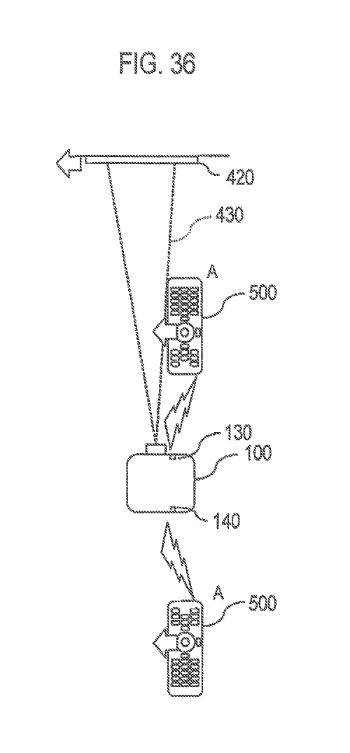

An example of directions in which the image 430 is moved by an operation of direction keys of the remote controller 500 from positions anterior to and posterior to the projection display apparatus 100 according to the eleventh modified example will be described with reference to the drawing. FIG. 36 is a view showing the directions in which the image 430 is moved by the operation of the direction keys of the remote controller 500 from the positions anterior to and posterior to the projection display apparatus 100, according to the eleventh modified example.

As shown in FIG. 36, the projection display apparatus 100 includes a front reception unit 130 and a rear reception unit 140 on its front and rear sides, respectively. The front reception unit 130 and the rear reception unit 140 each receive an infrared signal from the remote controller 500.

The front reception unit 130 is capable of receiving an infrared signal from a position anterior to the projection display apparatus 100 and incapable of receiving an infrared signal from a position posterior to the projection display apparatus 100.

The rear reception unit 140 is capable of receiving an infrared signal from a position posterior to the projection display apparatus 100 and incapable of receiving an infrared signal from a position anterior to the projection display apparatus 100.

Description will be given of moving the image 430 to the left as seen from the projection display apparatus 100 in states where the remote controller 500 is located anterior to the projection display apparatus 100 and where the remote controller 500 is located posterior to the projection display apparatus 100.

Description is first given of moving the image 430 in the state where the remote controller 500 is located anterior to the projection display apparatus 100. When a right direction key of the remote controller 500 is depressed in the state where the remote controller 500 is located anterior to the projection display apparatus 100 (A), an infrared signal from the remote controller 500 is received by the front reception unit 130. The imager controller 270 performs control such that the image 430 may be moved to the left in response to the infrared signal of the right direction key received by the front reception unit 130.

Description is next given of moving the image 430 in the state where the remote controller 500 is located posterior to the projection display apparatus 100. When a left direction key of the remote controller 500 is depressed in the state where the remote controller 500 is located posterior to the projection display apparatus 100 (B), an infrared signal from the remote controller 500 is received by the rear reception unit 140. The imager controller 270 performs control such that the image 430 may be moved to the left in response to the infrared signal of the left direction key received by the rear reception unit 140.

(Operation and Effect)

According to the eleventh modified example, when the image 430 is moved by an operation of direction keys of the remote controller 500, a direction in which the image 430 is moved by operating the remote controller 500 from a position anterior to the projection display apparatus 100 is opposite to a direction in which the image 430 is moved by operating the remote controller 500 from a position posterior to the projection display apparatus 100. This allows the user, who is located anterior to or posterior to the projection display apparatus 100, to operate the remote controller 500 so that the image 430 may move in the same direction as a direction instructed through the operation of a direction key of the remote controller 500, thus enabling an intuitive remote controller operation.

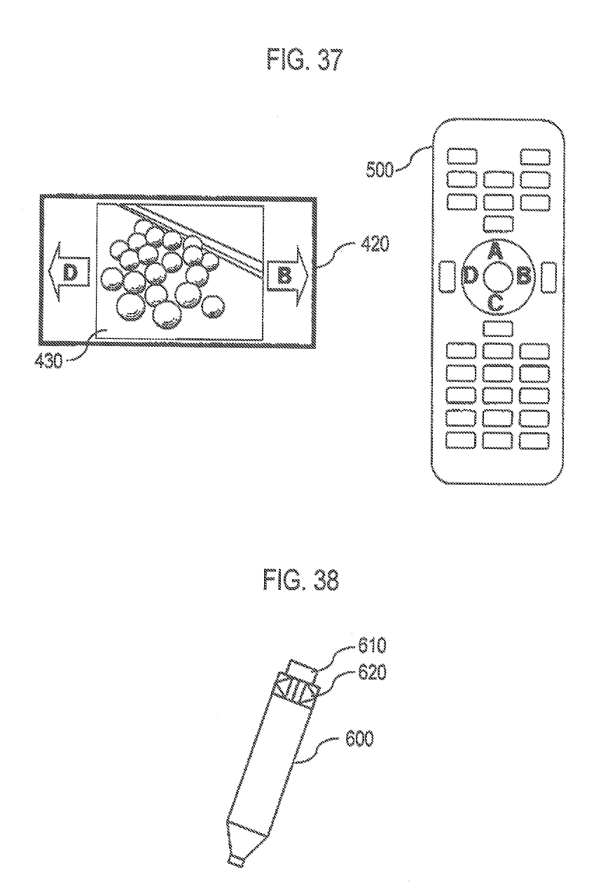

Note that, the eleventh modified example has illustrated a case where, when the image 430 is moved by an operation of direction keys of the remote controller 500, a direction in which the image 430 is moved by operating the remote controller 500 from a position anterior to the projection display apparatus 100 is opposite to a direction in which the image 430 is moved by operating the remote controller 500 from a position posterior to the projection display apparatus 100; however, the present invention is not limited to this case. For example, as shown in FIG. 37, the direction keys of the remote controller 500 may be given reference signs A to D, and the reference signs A to D may be associated with movement directions of the image 430. Alternatively, the direction keys may be given different colors instead of the reference signs.

### Twelfth Modified Example

A twelfth modified example of the first embodiment will be described below with reference to the drawing. In the following, description will be mainly given of a difference from the first embodiment.

Specifically, the projection display apparatus 100 in the twelfth modified example includes an interactive function with which the trajectory of a dedicated interactive pen 600 is imaged by the imaging device 300 constantly imaging the projection plane 400 and the imaged trajectory is displayed to overlap with the image 430. The interactive pen 600 functions as a remote controller for moving the image 430.

An example of the interactive pen 600 functions as a remote controller for moving the image 430 according to the twelfth modified example will be described below with reference to the drawings. FIG. 38 is a view showing the interactive pen 600 functions as a remote controller for moving the image 430, according to the twelfth modified example.

The projection display apparatus 100 in the twelfth modified example constantly images the projection plane 400 with the imaging device 300, and functions to display the trajectory of the dedicated interactive pen 600 shown in FIG. 38 drawn by the movement of the pen on the projection plane 400 so as to overlap with the image 430.

The interactive pen 600 includes a mode switch button 610 and a direction button 620.

The mode switch button 610 is used for switching the mode between an interactive mode for activating the interactive function and a display position movement mode for moving the image 430.

The direction button 620 is used for moving the image 430 when the mode is switched to the display position movement mode, and includes a pair of direction buttons. The image 430 is moved by depressing any one of the pair of direction buttons of the direction button 620.

(Operation and Effect)

According to the twelfth modified example, the mode switch button 610 provided in the interactive pen 600 allows switching the mode between the interactive mode and the display position movement mode. Thus, the user does not need to have a remote controller or the like in addition to the interactive pen when moving the image 430. This improves the usability for the user.

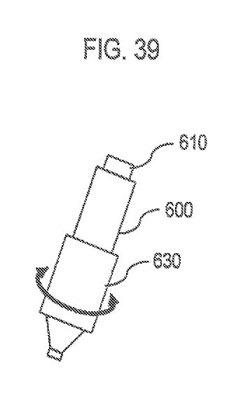

Note that, although the direction button 620 of the interactive pen 600 is used for the movement of the image 430 in the twelfth modified example, the present invention is not limited to this. As shown in FIG. 39, the movement of the image 430 may be controlled by a rotation detection sensor 630 of the interactive pen 600 which is a user interface for detecting rotation.

Further, although the direction button 620 of the interactive pen 600 is used for the movement of the image 430 in the twelfth modified example, the present invention is not limited to this. Alternatively, the movement of the image 430 may be controlled by detecting information on the trajectory of the interactive pen 600 and moving the image 430 in accordance with the detection result.

Further, although a pen-type device is used as the interactive pen 600 in the twelfth modified example, the present invention is not limited to this. Alternatively, the interactive function may be realized by using a laser pointer-type device and causing the imaging device 300 to detect laser light from the laser pointer.

Further, when the image 430 is moved using the interactive pen 600, the image 430 may be moved only in a uniaxial direction. In this case, a movable range in the lateral axial direction and a movable range in the vertical axial direction are compared with each other, and one of the directions in which the image is movable more greatly is selected to determine which axial direction to move the image 430.

Further, in a case where information (such as a clock) is displayed at a position other than the position where the image 430 is displayed, the information other than the image 430 may move in conjunction with the movement of the image 430 with their relative positional relation maintained.

### Other Embodiments

As described above, the present invention has been described by using the above embodiment. However, it should not be understood that the description and drawings which constitute part of this disclosure limit the present invention. From this disclosure, various alternative embodiments, examples, and operation techniques will be easily found by those skilled in the art.

In the above embodiment, a white light source has been illustrated as the light source. Alternatively, a LED (Light Emitting Diode) or a LD (Laser Diode) may be employed as the light source.

In the above embodiment, a transmissive liquid crystal panel has been illustrated as the imager. Alternatively, a reflective liquid crystal panel or a DMD (Digital Micromirror Device) may be employed as the imager.

In the above embodiment, the test pattern images shown in FIGS. 4 to 7 have been illustrated. However, the test pattern image is not limited to these. Further, description has been given of the case where the readout unit 230 includes a line memory. Alternatively, the readout unit 230 may include a frame memory.

In the above embodiment, the detection unit 240 detects the projection frame 420 on the basis of the image shot by the imaging device 300. Alternatively, the detection unit 240 may be a sensor (such as a light-amount sensor or an infrared sensor) for detecting spot light applied onto the projection plane 400 from a laser pointer or an infrared pointer.

In the above embodiment, description has been given of the imager controller 270 which functions to automatically perform keystone correction on the basis of the positional relation between the projection display apparatus 100 and the projection plane 400. However, the present invention is not limited to this. For example, the imager controller 270 may adjust a focus position or zooming magnification on the basis of the positional relation between the projection display apparatus 100 and the projection plane 400.

In the above first embodiment, the indicator indicating a movable direction of the image 430 is an arrow. However, the present invention is not limited to this. Alternatively, the indicator may be a character or the like.

Although not described in the above first embodiment, the color of the indicator may be changed into a certain color (for example red) when the image 430 is about to reach the edge of the projection frame 420. The change in the color of the indicator allows the user to notice that the image 430 is about to reach its movable limit. Alternatively, it is also possible to let the user notice that the image 430 is about to reach its movable limit through a character or the like.

The above first embodiment has illustrated the indicator indicating a direction in which an image projected on the projection plane 400 is movable in the projection frame. However, the present invention is not limited to this. The indicator may indicate a direction in which an image projected on the projection plane 400 can be expanded in the projection frame; alternatively, the indicator may indicate a direction in which an image projected on the projection plane 400 can be shrunk in the projection frame.

What is claimed is:

1. A projection display apparatus comprising:
an imager configured to modulate light emitted from a light source;
a projection unit configured to project light coming from the imager on a projection plane;
a detection unit configured to detect a projection frame provided on the projection plane; and
an imager controller configured to control the imager so that a position of an image projected on the projection plane is moved in a projectable range within which the projection unit is able to project an image, wherein
the imager controller controls the imager so that the image projected on the projection plane fits within the projection frame.

2. The projection display apparatus according to claim 1, wherein the imager controller controls the imager so that the imager displays any one of an indicator indicating a direction in which the image projected on the projection plane is movable in the projection frame and an indicator indicating a direction in which the image projected on the projection plane is expandable or shrinkable in the projection frame.

3. The projection display apparatus according to any one of claims 1 and 2, further comprising:
a projection unit controller configured to control the projection unit so that the projection unit moves a position of the projectable range, wherein
the imager controller controls the imager so that the image projected on the projection plane fits within the projection frame in conjunction with the movement of the position of the projectable range.

4. The projection display apparatus according to any one of claims 1 and 2, wherein the imager controller controls the imager so that the position of the image projected on the projection plane is moved in the projectable range in conjunction with expansion or shrinkage of the projectable range, without changing a center position of the image projected on the projection plane.

5. The projection display apparatus according to any one of claims 1 and 2, wherein the imager controller controls the imager so that the imager displays a candidate position at which the image projected on the projection plane is displayable in the projection frame.

6. The projection display apparatus according to any one of claims 1 and 2, wherein the detection unit detects the projection frame by detecting a detection target provided on the projection plane.

7. The projection display apparatus according to any one of claims 1 and 2, wherein
the imager controller includes a first operation mode and a second operation mode to control the imager,
the image projected on the projection plane is moved in certain moving steps in the first operation mode, and
the image projected on the projection plane is moved to reach an edge of a movable range of the image in the second operation mode.

8. The projection display apparatus according to any one of claims 1 and 2, further comprising:
a calculation unit configured to figure out a range in which the projectable range and the projection frame overlap with each other, wherein
the imager controller controls the imager so that the imager displays the overlap range figured out.

9. The projection display apparatus according to any one of claims 1 and 2, wherein, when the image projected on the projection plane is forced to move beyond a movable range of the image, the imager controller controls the imager so that a region where no image is projected is expanded in the projection frame.

10. The projection display apparatus according to any one of claims 1 and 2, wherein, when the image projected on the projection plane is forced to move beyond a movable range of the image, the imager controller controls the imager so that the image projected on the projection plane is made translucent.

11. The projection display apparatus according to any one of claims 1 and 2, further comprising:
a remote controller configured to transmit an instruction issued to the imager controller to move the position of the image projected on the projection plane; and
first and second reception units each configured to receive a signal transmitted from the remote controller, wherein
the imager controller controls the imager so that a direction in which the image projected on the projection plane is moved in response to the instruction received by the first reception unit from the remote controller is opposite to a direction in which the image projected on the projection plane is moved in response to the instruction received by the second reception unit from the remote controller.
